(19) United States
(12) Patent Application Publication
(10) Pub. No.: US 2026/0204481 A1
(43) Pub. Date: Jul. 16, 2026

(54) MULTILAYER CERAMIC CAPACITOR

(71) Applicant: Murata Manufacturing Co., Ltd., Nagaokakyo-shi (JP)

(72) Inventors: Akira ISHIZUKA, Nagaokakyo-shi (JP); Shinya ISOTA, Nagaokakyo-shi (JP)

(21) Appl. No.: 19/566,092

(22) Filed: Mar. 13, 2026

Related U.S. Application Data
(63) Continuation of application No. PCT/JP2024/034491, filed on Sep. 26, 2024.

(30) Foreign Application Priority Data
Dec. 25, 2023 (JP) 2023-218029

(51) Int. Cl. H01G 4/232; H01G 4/008; H01G 4/012; H01G 4/12; H01G 4/30

(52) U.S. Cl. CPC H01G 4/232; H01G 4/008; H01G 4/012; H01G 4/12; H01G 4/30

(57) ABSTRACT

A multilayer ceramic capacitor includes an inner layer portion including inner dielectric layers and inner electrode layers, and outer layer portions sandwiching the inner layer portion in a stacking direction. When a region between the first inner electrode layer at a center in the stacking direction and a fifth inner electrode layer from a first inner electrode layer at the center in the stacking direction toward the outer layer portion side is a region A and when the region between the first inner electrode layer closest to an outer layer portion side and the second inner electrode layer from the first inner electrode layer closest to the outer layer portion side toward the center in the stacking direction is a region B, a standard deviation of the ceramic grain diameters in the region A is larger than a standard deviation of the ceramic grain diameters in the region B.

### CROSS REFERENCE TO RELATED APPLICATIONS

This application claims the benefit of priority to Japanese Patent Application No. 2023-218029 filed on Dec. 25, 2023 and is a Continuation Application of PCT Application No. PCT/JP2024/034491 filed on Sep. 26, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Conventionally, with miniaturization and thinning of electronic device, miniaturization and thinning of a multilayer ceramic capacitor mounted in the electronic device have been demanded. In order to achieve miniaturization and thinning of the multilayer ceramic capacitor, thinning of dielectric layers is demanded.

However, when the dielectric layers are thinned, the possibility that dielectric breakdown occurs between inner electrode layers disposed so as to sandwich the dielectric layer increases. Further, when dielectric particles of the dielectric layer are made excessively small, there is also a possibility that a relative permittivity decreases.

Therefore, for example, as described in Japanese Unexamined Patent Application Publication No. 2019-179928, a multilayer ceramic capacitor is known in which an average particle diameter of dielectric particles in a portion forming a capacitance of the capacitor is made smaller than an average particle diameter of dielectric particles in other regions surrounding the portion generating a capacitance, thus reducing or preventing a decrease in relative permittivity and reducing a decrease in electrostatic capacitance.

### SUMMARY OF THE INVENTION

However, in the configuration described in Japanese Unexamined Patent Application Publication No. 2019-179928, since an average particle diameter of dielectric particles in the entire portion generating a capacitance of the multilayer ceramic capacitor is controlled, this alone is insufficient to suppress dielectric breakdown near an outer layer portion where failures are likely to occur.

Example embodiments of the present invention provide multilayer ceramic capacitors each capable of achieving miniaturization and thinning while reducing or preventing dielectric breakdown near an outer layer portion where failures are likely to occur and reducing or preventing a decrease in electrostatic capacitance.

The present inventors have discovered that, by adjusting a standard deviation of ceramic grain diameters of inner dielectric layers of an inner layer portion of a multilayer ceramic capacitor, dielectric breakdown near an outer layer portion and a decrease in electrostatic capacitance can be reduced or prevented even when the inner dielectric layers are thinned, and have conceived of and developed example embodiments of the present invention.

A multilayer ceramic capacitor according to an example embodiment of the present invention includes a multilayer body including an inner layer portion including a plurality of inner dielectric layers and a plurality of inner electrode layers alternately stacked in a stacking direction, and outer layer portions sandwiching the inner layer portion in the stacking direction, the multilayer body including a first main surface and a second main surface facing each other in the stacking direction, a first side surface and a second side surface facing each other in a width direction orthogonal to the stacking direction, and a first end surface and a second end surface facing each other in a length direction orthogonal to the stacking direction and the width direction, and a pair of outer electrodes at respective end portions of the multilayer body in the length direction so as to cover at least the first end surface and the second end surface and connected to the inner electrode layers, in which when among the plurality of inner electrode layers, a region between an inner electrode layer located at a center in the stacking direction and a fifth inner electrode layer from the inner electrode layer located at the center in the stacking direction toward an outer layer portion side is defined as a region A and when among the plurality of inner electrode layers, a region between an inner electrode layer located closest to the outer layer portion side and a second inner electrode layer from the inner electrode layer located closest to the outer layer portion side toward the center in the stacking direction is defined as a region B, a standard deviation of ceramic grain diameters of inner dielectric layers in the region A is larger than a standard deviation of ceramic grain diameters of an inner dielectric layer in the region B.

According to example embodiments of the present invention, it is possible to provide multilayer ceramic capacitors each capable of reducing or preventing dielectric breakdown near an outer layer portion where failures are likely to occur and reducing or preventing a decrease in electrostatic capacitance even when inner dielectric layers are thinned.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating a multilayer ceramic capacitor according to a first example embodiment of the present invention.

FIG. 2 is a cross-sectional view taken along line II-II (LT cross section) of the multilayer ceramic capacitor illustrated in FIG. 1.

FIG. 3 is a cross-sectional view taken along line III-III (WT cross section) of the multilayer ceramic capacitor illustrated in FIG. 1.

FIG. 4 is a schematic diagram illustrating a structure of an inner layer portion of the multilayer ceramic capacitor illustrated in FIG. 1.

FIGS. 5A and 5B are diagrams illustrating states of ceramic grains in respective regions (FIG. 5A region A, FIG. 5B region B).

FIG. 6 is a perspective view illustrating a multilayer ceramic capacitor according to a second example embodiment of the present invention.

FIG. 7 is a schematic diagram illustrating a structure of an inner layer portion of the multilayer ceramic capacitor illustrated in FIG. 6.

FIG. 8 is a perspective view illustrating a multilayer ceramic capacitor according to a third example embodiment of the present invention.

FIG. 9 is a schematic diagram illustrating a structure of an inner layer portion of the multilayer ceramic capacitor illustrated in FIG. 8.

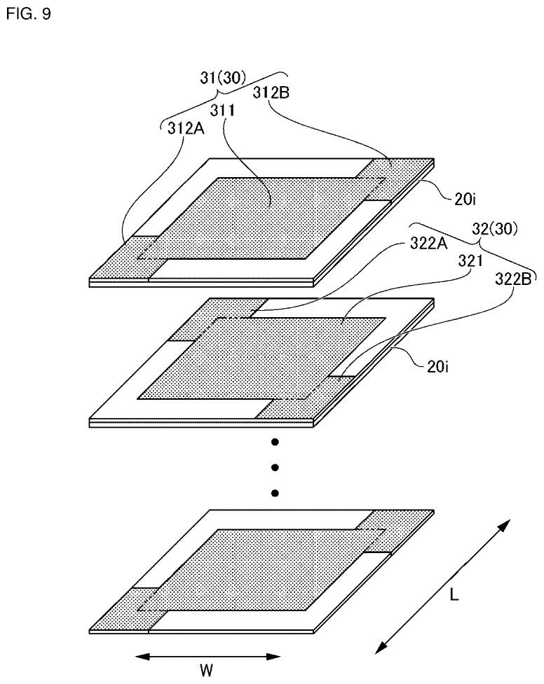

### DETAILED DESCRIPTION OF THE EXAMPLE EMBODIMENTS

Example embodiments of multilayer ceramic capacitors of the present invention will be described below, but the present invention is not limited thereto. The drawings may be schematically and simply drawn for explaining the contents of example embodiments of the present invention, and therefore ratios of dimensions of the illustrated components or between the components do not coincide with ratios of the dimensions described in the specification in some cases. Further, for example, in some cases, components described in the specification are omitted in the drawings, or components described in the specification are drawn with the number of the components being reduced.

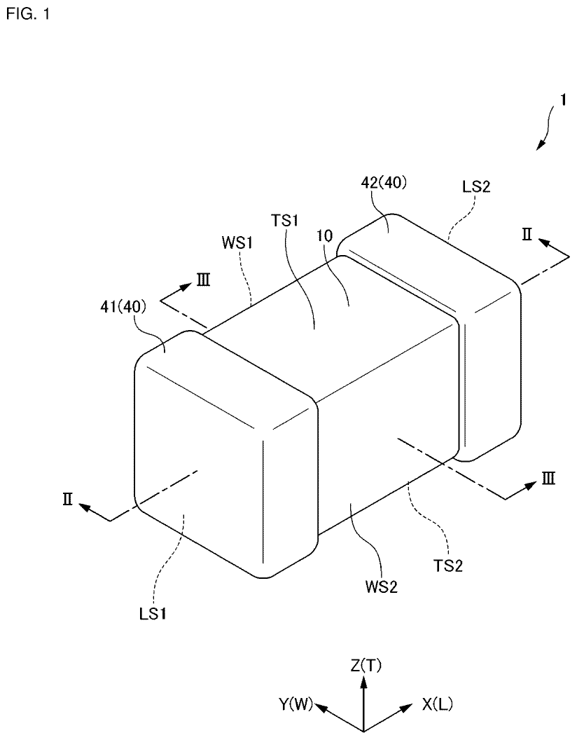

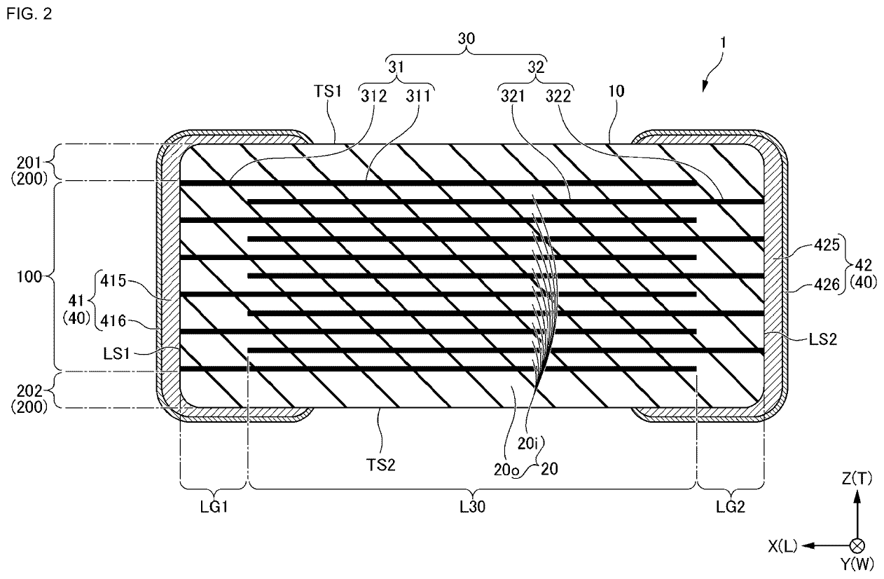

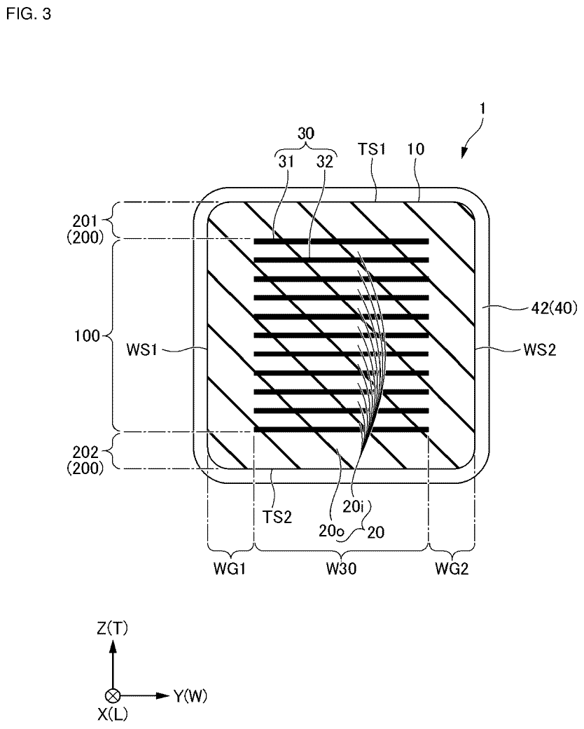

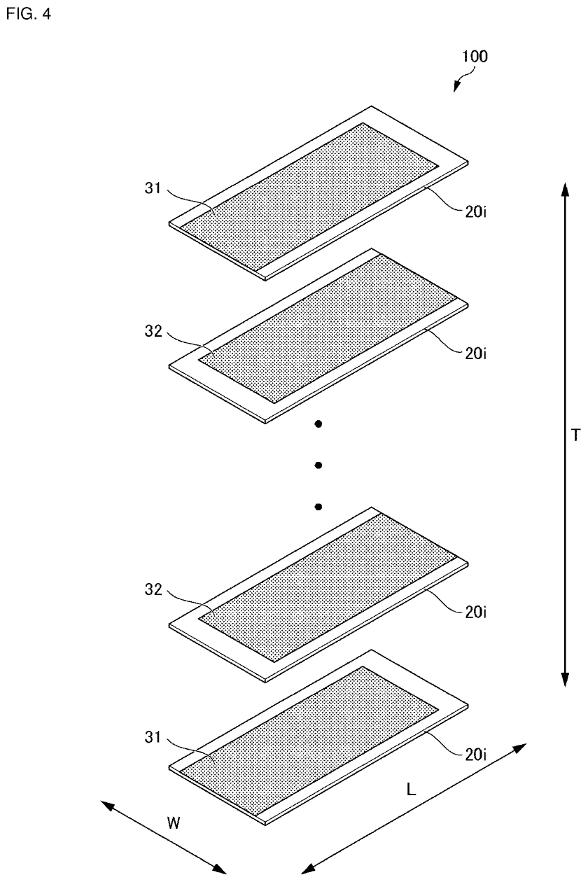

FIG. 1 is a perspective view illustrating a multilayer ceramic capacitor (first example embodiment). FIG. 2 is a cross-sectional view taken along line II-II of the multilayer ceramic capacitor illustrated in FIG. 1. FIG. 3 is a cross-sectional view taken along line III-III of the multilayer ceramic capacitor illustrated in FIG. 1. FIG. 4 is a schematic diagram illustrating a structure of an inner layer portion of the multilayer ceramic capacitor illustrated in FIG. 1. A multilayer ceramic capacitor 1 illustrated in FIGS. 1 to 4 includes a multilayer body 10 and outer electrodes 40. The outer electrodes 40 include a first outer electrode 41 and a second outer electrode 42.

An XYZ orthogonal coordinate system is illustrated in FIGS. 1 to 3. The X direction is a length direction L of the multilayer ceramic capacitor 1 and the multilayer body 10, the Y direction is a width direction W of the multilayer ceramic capacitor 1 and the multilayer body 10, and the Z direction is a stacking direction T of the multilayer ceramic capacitor 1 and the multilayer body 10. Accordingly, the cross section illustrated in FIG. 2 is also referred to as an LT cross section, and the cross section illustrated in FIG. 3 is also referred to as a WT cross section.

The length direction L, the width direction W, and the stacking direction T are not necessarily orthogonal to each other, and may intersect with each other.

The multilayer body 10 has a substantially rectangular parallelepiped shape, and includes a first main surface TS1 and a second main surface TS2 facing each other in the stacking direction T, a first side surface WS1 and a second side surface WS2 facing each other in the width direction W, and a first end surface LS1 and a second end surface LS2 facing each other in the length direction L. Irregularities may be provided on the respective surfaces, or the surfaces may be roughened.

It is preferable that corners and ridge portions of the multilayer body 10 are rounded. Each of the corners is a portion where three surfaces of the multilayer body 10 intersect, and each of the ridge portions is a portion where two surfaces of the multilayer body 10 intersect.

As illustrated in FIGS. 2 and 3, the multilayer body 10 includes a plurality of inner dielectric layers 20i and a plurality of inner electrode layers 30 stacked in the stacking direction T. Further, the multilayer body 10 includes an inner layer portion 100, and a first outer layer portion 201 and a second outer layer portion 202 disposed so as to sandwich the inner layer portion 100 in the stacking direction T.

The inner dielectric layers 20i constituting the inner layer portion 100 and outer dielectric layers 20o constituting outer layer portions 200 may have different component compositions since functions required of the inner layer portion 100 and the outer layer portions 200 differ. For example, a high dielectric constant is required of the inner dielectric layers 20i, and high moisture resistance, weather resistance, and strength are required of the outer dielectric layers 20o.

Therefore, dielectric layers of the inner layer portion 100 will be described as the inner dielectric layers 20i, and dielectric layers of the outer layer portions 200 will be described as the outer dielectric layers 20o. However, when it is not necessary to particularly distinguish between the inner dielectric layer 20i and the outer dielectric layer 20o, the inner dielectric layer 20i and the outer dielectric layer 20o will be collectively described as dielectric layers 20.

The inner layer portion 100 includes the plurality of inner dielectric layers 20i and the plurality of inner electrode layers 30. In the inner layer portion 100, the plurality of inner electrode layers 30 are disposed so as to face each other via the inner dielectric layers 20i. The inner layer portion 100 is a portion that generates electrostatic capacitance and substantially functions as a capacitor.

As a material of the dielectric layers 20, for example, a dielectric ceramic including, as a main component, BaTiO₃, CaTiO₃, SrTiO₃, CaZrO₃, or the like can be used. Further, as a material of the dielectric layers 20, an Mn compound, an Fe compound, a Cr compound, a Co compound, a Ni compound, or the like may be added as a subcomponent.

The thickness of the inner dielectric layers 20i is not particularly limited, but is preferably, for example, about 0.30 μm or more and about 0.45 μm or less, for example. By reducing the thickness of the inner dielectric layers 20i, electrostatic capacitance can be improved.

The first outer layer portion 201 is disposed on the first main surface TS1 side of the multilayer body 10, and the second outer layer portion 202 is disposed on the second main surface TS2 side of the multilayer body 10. More specifically, the first outer layer portion 201 is disposed between an inner electrode layer 30 closest to the first main surface TS1 among the plurality of inner electrode layers 30 and the first main surface TS1, and the second outer layer portion 202 is disposed between an inner electrode layer 30 closest to the second main surface TS2 among the plurality of inner electrode layers 30 and the second main surface TS2. The first outer layer portion 201 and the second outer layer portion 202 do not include the inner electrode layers 30.

The outer layer portions 200 include an insulating material. The first outer layer portion 201 and the second outer layer portion 202 can each include a plurality of outer dielectric layers 20o, but may each be constituted by a single outer dielectric layer 20o. Further, the outer dielectric layers 20o can be made of the same type of dielectric material as the inner dielectric layers 20i, but may include components different from those of the inner dielectric layers 20i depending on required functions. Further, the outer layer portions 200 can each be coated with a DLC film, and can include a different type of insulating material such as an insulating resin.

The plurality of inner electrode layers 30 include a plurality of first inner electrode layers 31 and a plurality of second inner electrode layers 32. The plurality of first inner electrode layers 31 and the plurality of second inner electrode layers 32 are alternately disposed in the stacking direction T of the multilayer body 10.

The first inner electrode layer 31 includes a first opposing electrode portion 311 and a first extended electrode portion 312, and the second inner electrode layer 32 includes a second opposing electrode portion 321 and a second extended electrode portion 322.

The first opposing electrode portion 311 and the second opposing electrode portion 321 face each other via the inner dielectric layer 20i in the stacking direction T of the multilayer body 10. The shape of the first opposing electrode portion 311 and the second opposing electrode portion 321 is not particularly limited, and may be, for example, a substantially rectangular shape. The first opposing electrode portion 311 and the second opposing electrode portion 321 are portions that generate electrostatic capacitance and substantially function as a capacitor.

The first extended electrode portion 312 extends from the first opposing electrode portion 311 to the first end surface LS1 of the multilayer body 10, and is exposed at the first end surface LS1. The second extended electrode portion 322 extends from the second opposing electrode portion 321 to the second end surface LS2 of the multilayer body 10, and is exposed at the second end surface LS2. A length in the width direction W of the first opposing electrode portion 311 and a length in the width direction W of the first extended electrode portion 312 may be the same, or may be different. Further, the lengths in the width direction W may gradually change toward the exposed first end surface LS1. A length in the width direction W of the second opposing electrode portion 321 and a length in the width direction W of the second extended electrode portion 322 may be the same, or may be different. Further, the lengths in the width direction W may gradually change toward the exposed second end surface LS2.

Thus, the first inner electrode layer 31 is connected to the first outer electrode 41, and a space is provided between the first inner electrode layer 31 and the second end surface LS2 of the multilayer body 10, that is, the second outer electrode 42. Further, the second inner electrode layer 32 is connected to the second outer electrode 42, and a space is provided between the second inner electrode layer 32 and the first end surface LS1 of the multilayer body 10, that is, the first outer electrode 41.

The first inner electrode layer 31 and the second inner electrode layer 32 include a metal Ni as a main component. Further, the first inner electrode layer 31 and the second inner electrode layer 32 may include, for example, at least one selected from metals such as Cu, Ag, Pd, Sn, and Au, or alloys including at least one of the metals, such as an Ag-Pd alloy, as a main component, or may include the at least one as a component other than the main component. Further, the first inner electrode layer 31 and the second inner electrode layer 32 may include, as a component other than the main component, particles of a dielectric having the same composition system as the ceramic included in the inner dielectric layer 20i. In the present specification, the main-component metal refers to a metal component having the highest weight percent.

The thickness of the first inner electrode layer 31 and the thickness of the second inner electrode layer 32 are not particularly limited, but are preferably, for example, about 0.30 μm or more and about 0.40 μm or less, and more preferably about 0.30 μm or more and about 0.35 μm or less. The number of the first inner electrode layers 31 and the number of the second inner electrode layers 32 are not particularly limited.

Examples of a method for measuring the thickness of each of the inner dielectric layers 20i and the inner electrode layers 30 include a method of observing, with a scanning electron microscope, an LT cross section in the vicinity of the center in the width direction of the multilayer body exposed by polishing. Each value may be an average of measured values at a plurality of locations in the length direction, or may be an average of measured values at a plurality of locations in the stacking direction.

As illustrated in FIG. 3, the multilayer body 10 includes, in the width direction W, an electrode opposing portion W30 where the inner electrode layers 30 face each other, and a first side gap portion WG1 and a second side gap portion WG2 disposed so as to sandwich the electrode opposing portion W30. The first side gap portion WG1 is located between the electrode opposing portion W30 and the first side surface WS1, and the second side gap portion WG2 is located between the electrode opposing portion W30 and the second side surface WS2. More specifically, the first side gap portion WG1 is located between ends of the inner electrode layers 30 on the first side surface WS1 side and the first side surface WS1, and the second side gap portion WG2 is located between ends of the inner electrode layers 30 on the second side surface WS2 side and the second side surface WS2. The first side gap portion WG1 and the second side gap portion WG2 do not include the inner electrode layers 30, and include only the dielectric layers 20. The first side gap portion WG1 and the second side gap portion WG2 are also each referred to as a W gap.

Si may be segregated in the first side gap portion WG1 and the second side gap portion WG2. Thus, the bending strength of the multilayer ceramic capacitor can be improved.

As illustrated in FIG. 2, the multilayer body 10 has, in the length direction L, an electrode opposing portion L30 where the first inner electrode layers 31 and the second inner electrode layers 32 of the inner electrode layers 30 face each other, a first end gap portion LG1, and a second end gap portion LG2. The first end gap portion LG1 is located between the electrode opposing portion L30 and the first end surface LS1, and the second end gap portion LG2 is located between the electrode opposing portion L30 and the second end surface LS2. More specifically, the first end gap portion LG1 is located between ends of the second inner electrode layers 32 on the first end surface LS1 side and the first end surface LS1, and the second end gap portion LG2 is located between ends of the first inner electrode layers 31 on the second end surface LS2 side and the second end surface LS2. The first end gap portion LG1 does not include the second inner electrode layers 32 and includes the first inner electrode layers 31 and the inner dielectric layers 20i, and the second end gap portion LG2 does not include the first inner electrode layers 31 and includes the second inner electrode layers 32 and the inner dielectric layers 20i. The first end gap portion LG1 is a portion that functions as an extended electrode portion of the first inner electrode layers 31 to the first end surface LS1, and the second end gap portion LG2 is a portion that functions as an extended electrode portion of the second inner electrode layers 32 to the second end surface LS2. The first end gap portion LG1 and the second end gap portion LG2 are also each referred to as an L gap.

The first opposing electrode portions 311 of the first inner electrode layers 31 and the second opposing electrode portions 321 of the second inner electrode layers 32 described above are located in the electrode opposing portion L30. Further, the first extended electrode portions 312 of the first inner electrode layers 31 described above are located in the first end gap portion LG1, and the second extended electrode portions 322 of the second inner electrode layers 32 described above are located in the second end gap portion LG2.

Examples of a method for measuring the thickness of the multilayer body 10 include a method of observing, with a scanning electron microscope, an LT cross section in the vicinity of the center in the width direction of the multilayer body exposed by polishing, or a WT cross section in the vicinity of the center in the length direction of the multilayer body exposed by polishing. Each value may be an average of measured values at a plurality of locations in the length direction or the width direction.

Similarly, examples of a method for measuring the length of the multilayer body 10 include a method of observing, with a scanning electron microscope, an LT cross section in the vicinity of the center in the width direction of the multilayer body exposed by polishing. Each value may be an average of measured values at a plurality of locations in the stacking direction.

Similarly, examples of a method for measuring the width of the multilayer body 10 include a method of observing, with a scanning electron microscope, a WT cross section in the vicinity of the center in the length direction of the multilayer body exposed by polishing. Each value may be an average of measured values at a plurality of locations in the stacking direction.

The outer electrodes 40 include the first outer electrode 41 and the second outer electrode 42.

The first outer electrode 41 is disposed on the first end surface LS1 of the multilayer body 10, and is connected to the first inner electrode layers 31. The first outer electrode 41 may extend from the first end surface LS1 to a portion of the first main surface TS1 and a portion of the second main surface TS2. Further, the first outer electrode 41 may extend from the first end surface LS1 to a portion of the first side surface WS1 and a portion of the second side surface WS2.

The second outer electrode 42 is disposed on the second end surface LS2 of the multilayer body 10 and is connected to the second inner electrode layers 32. The second outer electrode 42 may extend from the second end surface LS2 to a portion of the first main surface TS1 and a portion of the second main surface TS2. Further, the second outer electrode 42 may extend from the second end surface LS2 to a portion of the first side surface WS1 and a portion of the second side surface WS2.

The first outer electrode 41 includes a first base electrode layer 415 and a first plating layer 416, and the second outer electrode 42 has a second base electrode layer 425 and a second plating layer 426. The first outer electrode 41 may include only by the first plating layer 416, and the second outer electrode 42 may include only by the second plating layer 426.

The first base electrode layer 415 and the second base electrode layer 425 may be fired layers including metal and glass. Examples of the glass include a glass component including at least one selected from, for example, B, Si, Ba, Mg, Al, and Li. As a specific example, borosilicate glass can be used. The metal includes Cu as a main component. Further, the metal may include, for example, at least one selected from metals such as Ni, Ag, Pd, and Au, or alloys such as an Ag-Pd alloy, as a main component, or may include the at least one as a component other than the main component.

The fired layer is a layer formed by applying, by a dipping method, a conductive paste including metal and glass to the multilayer body and firing the conductive paste. The layer may be fired after firing of the inner electrode layers, or may be fired simultaneously with the inner electrode layers. Further, the fired layer may include a plurality of layers.

Alternatively, the first base electrode layer 415 and the second base electrode layer 425 may be resin layers including conductive particles and a thermosetting resin. The resin layer may be formed on the fired layer described above, or may be formed directly on the multilayer body without formation of the fired layer.

The resin layer is a layer formed by applying, by an application method, a conductive paste including conductive particles and a thermosetting resin to the multilayer body and firing the conductive paste. The layer may be fired after firing of the inner electrode layers, or may be fired simultaneously with the inner electrode layers. Further, the resin layer may include a plurality of layers.

The thickness of each of the first base electrode layer 415 and the second base electrode layer 425 as the fired layers or the resin layers is not particularly limited, and may be about 1 μm or more and about 10 μm or less, for example.

Alternatively, the first base electrode layer 415 and the second base electrode layer 425 may be thin film layers having a thickness of about 1 μm or less, for example, formed by a thin film formation method such as a sputtering method or a vapor deposition method, and including deposited metal particles.

The first plating layer 416 covers at least a portion of the first base electrode layer 415, and the second plating layer 426 covers at least a portion of the second base electrode layer 425. The first plating layer 416 and the second plating layer 426 include, for example, at least one selected from metals such as Cu, Ni, Ag, Pd, and Au, or alloys such as an Ag-Pd alloy.

The first plating layer 416 and the second plating layer 426 may include a plurality of layers. Preferably, the first plating layer 416 and the second plating layer 426 each have a two-layer structure including Ni plating and Sn plating. The Ni plating layer can prevent the base electrode layer from being eroded by solder when a ceramic electronic component is mounted, and the Sn plating layer can improve solder wettability when the ceramic electronic component is mounted, thus enabling easy mounting. The first plating layer 416 and the second plating layer 426 can each have a three-layer structure formed, for example, by stacking Sn plating, Ni plating, and Sn plating. The outermost layer may be Au plating.

The thickness of each of the first plating layer 416 and the second plating layer 426 is not particularly limited, and may be about 1 μm or more and about 10 μm or less, for example.

The ceramic grain diameter D50 of the inner dielectric layer in a region B is preferably about 80 nm or more and about 150 nm or less, for example. Thus, since the number of ceramic grains included in the inner dielectric layer 20i can be increased, interfaces between ceramic grains increase, and high-temperature reliability is improved.

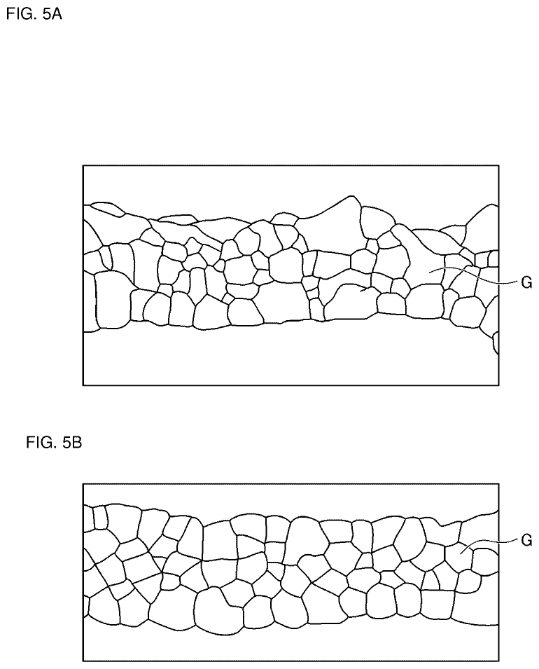

When among the plurality of stacked inner electrode layers 30, the region between the inner electrode layer 30 located at the center in the stacking direction T and the fifth inner electrode layer 30 from the inner electrode layer 30 located at the center in the stacking direction T toward the outer layer portion 200 side is defined as a region A and when among the plurality of inner electrode layers 30, the region between the inner electrode layer 30 located closest to the outer layer portion 200 side and the second inner electrode layer 30 from the inner electrode layer 30 located closest to the outer layer portion 200 side toward the center in the stacking direction T is defined as a region B, the standard deviation σ_{A} of the ceramic grain diameters of the inner dielectric layers 20i in the region A is larger than the standard deviation σ_{B} of the ceramic grain diameters of the inner dielectric layer 20i in the region B (FIGS. 5A and 5B).

The standard deviation σ of ceramic grain diameters can be obtained by measuring, using an SEM, a WT cross section at the center in the length direction L of the multilayer ceramic capacitor 1 or an LT cross section at the center in the width direction W of the multilayer ceramic capacitor 1 to calculate, from ceramic grain diameters of the inner dielectric layers 20i in the region A and the region B, the standard deviation σ_{A} in the region A and the standard deviation σ_{B} in the region B.

By making the standard deviation σ_{A} of the grain diameters of the inner dielectric layers 20i in the region A larger than the standard deviation σ_{B} of the grain diameters of the inner dielectric layer 20i in the region B, the proportion of ceramic grains having a large grain diameter in the inner dielectric layers 20i near the center in the stacking direction T of the multilayer ceramic capacitor can be increased, and therefore electrostatic capacitance can be improved while maintaining high-temperature reliability.

On the other hand, since the region B is a region where failures are likely to occur, by making the standard deviation σ_{B} in the region B smaller than the standard deviation σ_{A} in the region A and reducing variation in ceramic grain diameter, the number of ceramic grains in the region B can be increased and high-temperature reliability can be improved.

The standard deviation σ_{A} of the ceramic grain diameters of the inner dielectric layers 20i in the region A is preferably about 20 nm or more and about 120 nm or less, for example. Further, the standard deviation σ_{B} of the ceramic grain diameters of the inner dielectric layer 20i in the region B is preferably about 10 nm or more and about 50 nm or less, for example.

The inner dielectric layer 20i in the region B may have a smaller thickness in the stacking direction than the inner dielectric layer 20i in the region A.

A ratio (σ_{A}/σ_{B}) between the standard deviation σ_{A} of the ceramic grain diameters of the inner dielectric layers in the region A and the standard deviation σ_{B} of the ceramic grain diameters of the inner dielectric layer in the region B is preferably about 1.1 or more and about 3.0 or less, for example.

Further, when among the plurality of stacked inner electrode layers 30, the region B is defined as a region between the inner electrode layer 30 located closest to the outer layer portion 200 side and the tenth inner electrode layer 30 from the inner electrode layer 30 located closest to the outer layer portion 200 side toward the center in the stacking direction T and when the standard deviation σ_{A} of the ceramic grain diameters of the inner dielectric layers 20i in the region A is made larger than the standard deviation σ_{B} of the ceramic grain diameters of the inner dielectric layers 20i in the region B, it becomes possible to more reliably improve electrostatic capacitance and high-temperature reliability.

Next, an example of a method for manufacturing the multilayer ceramic capacitor 1 described above will be described.

Dielectric sheets for the dielectric layers 20 and a conductive paste for the inner electrode layers 30 are prepared. The dielectric sheets and the conductive paste include a binder and a solvent. As the binder and the solvent, known materials can be used.

Since the dielectric sheets need to be formed by distinguishing a dielectric sheet disposed at a position corresponding to the region A from a dielectric sheet disposed at a position corresponding to the region B, an inner dielectric paste for the region A and an inner dielectric paste for the region B are used.

The inner dielectric paste for the region A is prepared by mixing and blending a material a and a material b having different ceramic grain diameters.

For example, the inner dielectric paste for the region A includes about 1 vol % to about 50 vol % of the material b having a ceramic grain diameter larger than that of the material a by about 10 nm to about 20 nm or more. In this case, when too much of the material b is blended, or when the ceramic grain diameter of the material b is excessively large, the average ceramic grain diameter D50 of the entire material included in the inner dielectric paste for the region A becomes large, and improvement in high-temperature reliability cannot be sufficiently achieved.

The dielectric paste for the region B includes a material having smaller variation in ceramic grain diameter than the materials blended in the inner dielectric paste for the region A.

Thereafter, by printing each of the inner dielectric paste for the region A and the inner dielectric paste for the region B on a PET film, an inner dielectric sheet for the region A and an inner dielectric sheet for the region B can be formed.

Next, an inner electrode pattern is formed on the dielectric sheet by printing the conductive paste on the dielectric sheet in, for example, a predetermined pattern. As a method for forming the inner electrode pattern, screen printing, gravure printing, or the like can be used.

Next, a predetermined number of dielectric sheets for the second outer layer portion 202 on which the inner electrode pattern is not printed are stacked. Thereon, the dielectric sheets for the inner layer portion 100 on which the inner electrode pattern is printed are sequentially stacked. Thereon, a predetermined number of dielectric sheets for the first outer layer portion 201 on which the inner electrode pattern is not printed are stacked. Thus, a multilayer sheet is produced.

Next, the multilayer sheet is pressed in the stacking direction by hydrostatic pressing or other methods to produce a multilayer block. Next, the multilayer block is cut into a predetermined size to cut out multilayer chips. At this time, corners and ridge portions of the multilayer chips are rounded by barrel polishing or the like.

The multilayer chips may be cut such that the inner electrode pattern is exposed on both side surfaces in the width direction W, and dielectric sheets for covering that are to be the first side gap portion WG1 and the second side gap portion WG2 may be attached so as to cover the both side surfaces.

Next, the multilayer chip is fired to produce the multilayer body 10. The firing temperature depends on materials of the dielectric and the inner electrodes, but is preferably about 900° C. or more and about 1400° C. or less, for example.

Next, by using a dipping method to immerse the first end surface LS1 of the multilayer body 10 in a conductive paste serving as an electrode material for a base electrode layer, the conductive paste for the first base electrode layer 415 is applied to the first end surface LS1. Similarly, by using the dipping method to immerse the second end surface LS2 of the multilayer body 10 in the conductive paste serving as an electrode material for the base electrode layer, the conductive paste for the second base electrode layer 425 is applied to the second end surface LS2. Thereafter, by firing the conductive paste, the first base electrode layer 415 and the second base electrode layer 425, which are fired layers, are formed. The firing temperature is preferably about 600° C. or more and about 900° C. or less, for example.

As described above, the first base electrode layer 415 and the second base electrode layer 425, which are resin layers, may be formed by applying, by an application method, a conductive paste including conductive particles and a thermosetting resin and firing the conductive paste, or the first base electrode layer 415 and the second base electrode layer 425, which are thin films, may be formed by a thin film formation method such as a sputtering method or a vapor deposition method.

Thereafter, the first outer electrode 41 is formed by forming the first plating layer 416 on a surface of the first base electrode layer 415, and the second outer electrode 42 is formed by forming the second plating layer 426 on a surface of the second base electrode layer 425. Through the above steps, the multilayer ceramic capacitor 1 is obtained.

Example embodiments of the present invention are not limited to the shape and the like of the multilayer ceramic capacitor 1, and can be widely used as long as the multilayer ceramic capacitor 1 includes the inner layer portion 100 formed by stacking the inner dielectric layers 20i and the inner electrode layers 30.

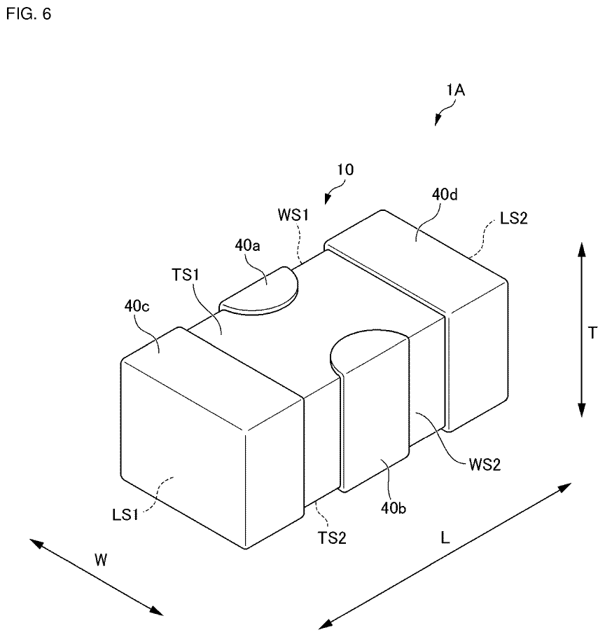

For example, as illustrated in FIG. 6, there is a multilayer ceramic capacitor 1A including outer electrodes 40a and 40b on the first side surface WS1 and the second side surface WS2 of the multilayer body 10, respectively, and including outer electrodes 40c and 40d on the first end surface LS1 and the second end surface LS2 of the multilayer body 10, respectively.

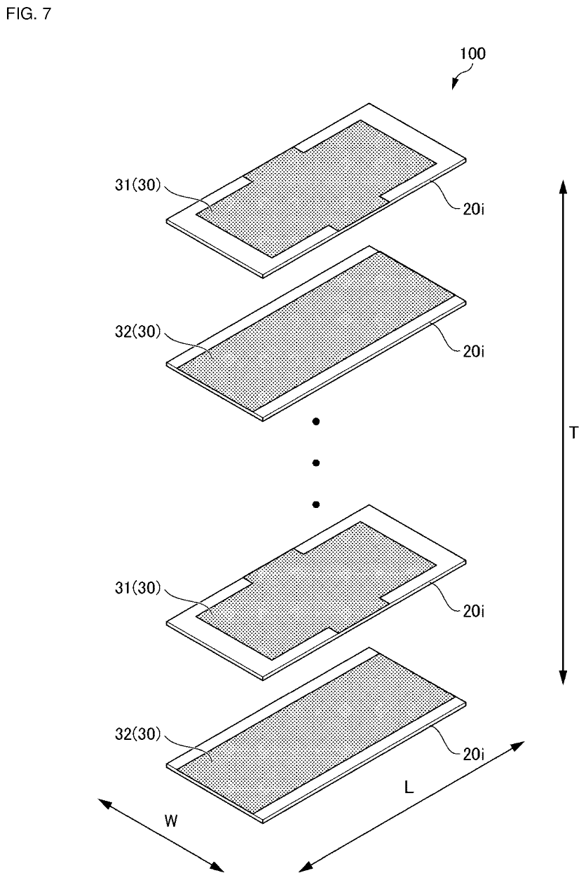

As illustrated in FIG. 7, the inner layer portion 100 includes a plurality of inner dielectric layers 20i and a plurality of inner electrode layers 30. The inner layer portion 100 includes, in the stacking direction T, inner electrode layers 30 from the inner electrode layer 30 located closest to the first main surface TS1 side to the inner electrode layer 30 located closest to the second main surface TS2 side. In the inner layer portion 100, the plurality of inner electrode layers 30 are disposed so as to face each other via the inner dielectric layers 20i.

The plurality of inner electrode layers 30 include a plurality of first inner electrode layers 31 and a plurality of second inner electrode layers 32. The plurality of first inner electrode layers 31 are disposed on the plurality of inner dielectric layers 20i. The plurality of second inner electrode layers 32 are disposed on the plurality of inner dielectric layers 20i. The plurality of first inner electrode layers 31 and the plurality of second inner electrode layers 32 are alternately disposed in the stacking direction T of the multilayer body 10 via the inner dielectric layers 20i. The first inner electrode layers 31 and the second inner electrode layers 32 are disposed so as to sandwich the inner dielectric layers 20i.

The first inner electrode layers 31 are connected to the outer electrodes 40a and 40b at the first side surface WS1 and the second side surface WS2 of the multilayer body 10, and the second inner electrode layers 32 are connected to the outer electrodes 40c and 40d at the first end surface LS1 and the second end surface LS2 of the multilayer body 10.

The multilayer ceramic capacitor 1A can be used as a three-terminal capacitor by, in a circuit, dividing a power supply line or a signal line in the middle, connecting the outer electrode 40c to one of the divided portions, connecting the outer electrode 40d to the other of the divided portions, and connecting the outer electrodes 40a and 40b to ground. In this case, the second inner electrode layers 32 are through electrodes, and the first inner electrode layers 31 are ground electrodes.

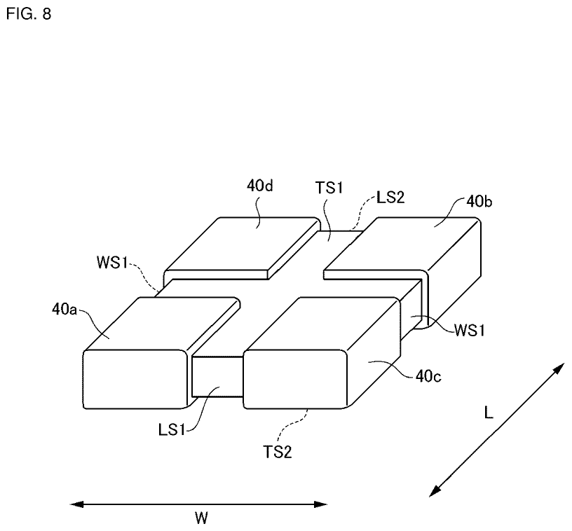

Further, as illustrated in FIG. 8, there is a multilayer ceramic capacitor 1B including four outer electrodes 40a, 40b, 40c, and 40d. The inner layer portion 100 includes a plurality of inner dielectric layers 20i and a plurality of inner electrode layers 30. The inner layer portion 100 includes, in the stacking direction T, inner electrode layers 30 from the inner electrode layer 30 located closest to the first main surface TS1 side to the inner electrode layer 30 located closest to the second main surface TS2 side. In the inner layer portion 100, the plurality of inner electrode layers 30 are disposed so as to face each other via the inner dielectric layers 20i.

The plurality of inner electrode layers 30 include a plurality of first inner electrode layers 31 and a plurality of second inner electrode layers 32. The plurality of first inner electrode layers 31 are disposed on the plurality of inner dielectric layers 20i. The plurality of second inner electrode layers 32 are disposed on the plurality of inner dielectric layers 20i. The plurality of first inner electrode layers 31 and the plurality of second inner electrode layers 32 are alternately disposed in the stacking direction T of the multilayer body 10 via the inner dielectric layers 20i. The first inner electrode layers 31 and the second inner electrode layers 32 are disposed so as to sandwich the inner dielectric layers 20i.

The first inner electrode layer 31 includes a first opposing electrode portion 311 facing the second inner electrode layer 32, a first extended portion 312A extended from the first opposing electrode portion 311 to the first end surface LS1 and the first side surface WS1, and a second extended portion 312B extended from the first opposing electrode portion 311 to the second end surface LS2 and the second side surface WS2. The first extended portion 312A is exposed at the first end surface LS1 and the first side surface WS1. The second extended portion 312B is exposed at the second end surface LS2 and the second side surface WS2.

The second inner electrode layer 32 includes a second opposing electrode portion 321 facing the first inner electrode layer 31, a first extended portion 322A extended from the second opposing electrode portion 321 to the second end surface LS2 and the first side surface WS1, and a second extended portion 322B extended from the second opposing electrode portion 321 to the first end surface LS1 and the second side surface WS2. The first extended portion 322A is exposed at the second end surface LS2 and the first side surface WS1. The second extended portion 322B is exposed at the first end surface LS1 and the second side surface WS2.

In the present example embodiment, a capacitance is generated by the first opposing electrode portion 311 and the second opposing electrode portion 321 facing each other via the inner dielectric layer 20i, and capacitor characteristics are exhibited.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion including a plurality of inner dielectric layers and a plurality of inner electrode layers alternately stacked in a stacking direction, and outer layer portions sandwiching the inner layer portion in the stacking direction, the multilayer body including a first main surface and a second main surface facing each other in the stacking direction, a first side surface and a second side surface facing each other in a width direction orthogonal to the stacking direction, and a first end surface and a second end surface facing each other in a length direction orthogonal to the stacking direction and the width direction; and
a pair of outer electrodes at respective end portions of the multilayer body in the length direction so as to cover at least the first end surface and the second end surface and connected to the inner electrode layers; wherein
when among the plurality of inner electrode layers, a region between an inner electrode layer located at a center in the stacking direction and a fifth inner electrode layer from the inner electrode layer located at the center in the stacking direction toward an outer layer portion side is defined as a region A and when among the plurality of inner electrode layers, a region between an inner electrode layer located closest to the outer layer portion side and a second inner electrode layer from the inner electrode layer located closest to the outer layer portion side toward the center in the stacking direction is defined as a region B, a standard deviation σ_{A} of ceramic grain diameters of inner dielectric layers in the region A is larger than a standard deviation σ_{B} of ceramic grain diameters of an inner dielectric layer in the region B.

2. The multilayer ceramic capacitor according to claim 1, wherein when among the plurality of inner electrode layers, a region between the inner electrode layer located closest to the outer layer portion side and a tenth inner electrode layer from the inner electrode layer located closest to the outer layer portion side toward the center in the stacking direction is defined as a region B, the standard deviation σ_{A} of the ceramic grain diameters of the inner dielectric layers in the region A is larger than a standard deviation σ_{B} of ceramic grain diameters of inner dielectric layers in the region B.

3. The multilayer ceramic capacitor according to claim 1, wherein a ratio (σ_{A}/σ_{B}) between the standard deviation σ_{A} of the ceramic grain diameters of the inner dielectric layers in the region A and the standard deviation σ_{B} of the ceramic grain diameters of the inner dielectric layer in the region B is about 1.1 or more and about 3.0 or less.

4. The multilayer ceramic capacitor according to claim 1, wherein a ceramic grain diameter D50 of the inner dielectric layer in the region B is about 80 nm or more and about 150 nm or less.

5. The multilayer ceramic capacitor according to claim 1, wherein a thickness in the stacking direction of each of the inner dielectric layers is about 0.30 μm or more and about 0.45 μm or less.

6. The multilayer ceramic capacitor according to claim 1, wherein the multilayer body has a substantially rectangular parallelepiped shape.

7. The multilayer ceramic capacitor according to claim 1, wherein the multilayer body includes rounded corners and rounded ridge portions.

8. The multilayer ceramic capacitor according to claim 1, wherein each of the pair of outer electrodes includes a base electrode layer and a plating layer.

9. The multilayer ceramic capacitor according to claim 1, wherein each of the pair of outer electrodes includes only a plating layer.

10. The multilayer ceramic capacitor according to claim 8, wherein the base electrode layer includes metal and glass.

11. The multilayer ceramic capacitor according to claim 8, wherein the plating layer includes a Ni plating layer and an Sn plating layer.

12. The multilayer ceramic capacitor according to claim 9, wherein the plating layer includes a Ni plating layer and an Sn plating layer.

13. The multilayer ceramic capacitor according to claim 1, wherein the standard deviation σ_{A} of the ceramic grain diameters of the inner dielectric layers in the region A is about 20 nm or more and about 120 nm or less.

14. The multilayer ceramic capacitor according to claim 1, wherein the standard deviation σ_{B} of the ceramic grain diameters of the inner dielectric layer in the region is about 10 nm or more and about 50 nm or less.

15. The multilayer ceramic capacitor according to claim 1, wherein the inner dielectric layer in the region B has a smaller thickness in the stacking direction than the inner dielectric layer in the region A.

16. The multilayer ceramic capacitor according to claim 1, wherein the multilayer ceramic capacitor is a three terminal capacitor.

17. The multilayer ceramic capacitor according to claim 1, wherein the multilayer ceramic capacitor includes a total of four outer electrodes.
